(19) United States
(12) Patent Application Publication
(10) Pub. No.: US 2025/0377800 A1
(43) Pub. Date: Dec. 11, 2025

(54) MEMORY SYSTEM, COMPUTER SYSTEM AND DATA INTERACTION METHOD

(71) Applicant: MONTAGE TECHNOLOGY (KUNSHAN) CO., LTD., Suzhou (CN)

(72) Inventors: Gang YAN, Suzhou (CN); Yibo JIANG, Suzhou (CN); Roland KNAACK, Suzhou (CN)

(21) Appl. No.: 19/218,586

(22) Filed: May 26, 2025

(30) Foreign Application Priority Data
May 24, 2024 (CN) 202410658828.X
May 23, 2025 (CN) 202510670537.7

(51) Int. Cl. G06F 3/06

(52) U.S. Cl. CPC G06F 3/0613; G06F 3/0656; G06F 3/0673

(57) ABSTRACT

The present application provides a memory system. The memory system includes a memory controller, a memory and a data buffer coupled between the memory controller and the memory. The memory controller and the data buffer are coupled to each other via a first data bus and a first data strobe signal bus. The first data strobe signal bus is used to transmit a first data strobe signal for sampling control of a first data signal. The first data strobe signal bus is a bidirectional differential signal bus. The memory and the data buffer are coupled to each other via a second data bus and a second data strobe signal bus. The second data strobe signal bus is used to transmit a second data strobe signal for sampling control of a second data signal. The second data strobe signal bus is a bidirectional differential signal bus.

### TECHNICAL FIELD

The present application generally relates to the field of memory technologies, and more particularly, to a memory system, a computer system and a data interaction method.

### BACKGROUND OF THE INVENTION

Single-ended bi-directional source synchronous signal transmission has been used for data (DQ) signals in interface circuits of double data rate dynamic random-access memories (DDR DRAM, or DRAM). A multi-bit DQ signal (e.g., a 4-bit or 8-bit DQ signal, accompanied by a pair of differential data strobe (DQS) signals) may be configured with a write direction to write data into the DDR DRAM, or with a read direction to read data from the DDR DRAM. FIGS. 1(a) and 1(b) illustrate diagrams in which a host (or a memory controller) accesses a DRAM with a bit width of 4 bits (x4 DRAM) and a DRAM with a bit width of 8 bits (x8 DRAM), respectively. The DQS signals are transmitted together with the DQ signal, serving as a receive clock signal for sampling the multi-bit DQ signal. The DQS signals are also referred to as a data strobe signal, and a bus for transmitting the DQS signals is referred to as a data strobe bus. For a write operation, the host (or the memory controller) transmits the multi-bit DQ signal together with the DQS signals to the DRAM, meaning that the host is a signal transmitter and the DRAM is a signal receiver. Conversely, for a read operation, the DRAM is a signal transmitter and the host is a signal receiver.

As access speed increases, single-ended DQ interfaces encounter severe crosstalk issues, which pose challenges to signal transmission. For the next-generation DDR interface following the DDR5 interface, the data rate is expected to exceed 10 Gbps, and the crosstalk is a major factor affecting signal integrity in future high-speed DDR interfaces.

Therefore, there is a need to further improve existing memory systems.

### SUMMARY OF THE INVENTION

An objective of the present application is to provide a memory system, a computer system and a data interaction method.

According to an aspect of the present application, a memory system is provided. The memory system comprises a memory controller, a memory and a data buffer coupled between the memory controller and the memory, and configured to buffer data interacted between the memory controller and the memory; wherein the memory controller and the data buffer are coupled to each other via a first data bus and a first data strobe signal bus, the first data bus being configured to transmit a first data signal, and the first data strobe signal bus being configured to transmit a first data strobe signal for sampling control of the first data signal, wherein the first data bus and the first data strobe signal bus are both bidirectional differential signal buses; and wherein the memory and the data buffer are coupled to each other via a second data bus and a second data strobe signal bus, the second data bus being configured to transmit a second data signal, and the second data strobe signal bus being configured to transmit a second data strobe signal for sampling control of the second data signal, wherein the second data bus is a single-ended signal bus, and the second data strobe signal bus is a bidirectional differential signal bus.

According to another aspect of the present application, another memory system is provided. The memory system comprises: a memory and a data buffer; wherein the data buffer comprises a first data signal port and a first data strobe signal port, the data buffer being configured to be coupled to a first data bus via the first data signal port, thereby coupled to a memory controller via the first data bus, and further configured to be coupled to a first data strobe signal bus via the first data strobe signal port, thereby coupled to the memory controller via the first data strobe signal bus; wherein the first data bus is configured to transmit a first data signal, and the first data strobe signal bus is configured to transmit a first data strobe signal for sampling control of the first data signal, wherein the first data signal port and the first data strobe signal port are both bidirectional differential signal ports; and wherein the memory and the data buffer are coupled to each other via a second data bus and a second data strobe signal bus, the second data bus being configured to transmit a second data signal, and the second data strobe signal bus being configured to transmit a second data strobe signal for sampling control of the second data signal, wherein the second data bus is a single-ended signal bus, and the second data strobe signal bus is a bidirectional differential signal bus.

According to a further aspect of the present application, another memory system is provided. The memory system includes a memory controller and a data buffer. The memory controller and the data buffer are coupled to each other via a first data bus and a first data strobe signal bus. The first data bus is used to transmit a first data signal, and the first data strobe signal bus is used to transmit a first data strobe signal for sampling control of the first data signal. Both the first data bus and the first data strobe signal bus are bidirectional differential signal buses. The data buffer includes a second data signal port and a second data strobe signal port. The data buffer is coupled to a second data bus via the second data signal port, and further coupled to a memory via the second data bus. The data buffer is also coupled to a second data strobe signal bus via the second data strobe signal port, and further coupled to the memory via the second data strobe signal bus. The second data bus is used to transmit a second data signal, and the second data strobe signal bus is used to transmit a second data strobe signal for sampling control of the second data signal. The second data signal port is a single-ended signal port, and the second data strobe signal port is a bidirectional differential signal port.

According to a further aspect of the present application, a computer system is provided. The computer system includes a host, a memory and a data buffer. The data buffer is located between the host and the memory and is used to buffer data interacted between the host and the memory. The host and the data buffer are coupled to each other via a bidirectional differential DQ bus and a bidirectional differential DQS bus. DQS signals on the bidirectional differential DQS bus are used to sample DQ signals on the bidirectional differential DQ bus. The memory and the data buffer are coupled to each other via a bidirectional single-ended DQ bus and a bidirectional differential DQS bus.

According to a further aspect of the present application, another computer system is provided. The computer system includes a host and a memory. The host and the memory are coupled via a bidirectional differential DQ bus and a bidirectional differential DQS bus, and DQS signals on the bidirectional differential DQS bus is used to sample DQ signals on the bidirectional differential DQ data bus. In this embodiment, the host and the memory are directly connected without passing through a data buffer.

According to a further aspect of the present application, a data interaction method for a memory system is provided. The memory system comprises a memory controller, a memory, and a data buffer, the data buffer being coupled between the memory controller and the memory, the memory controller and the data buffer being coupled to each other via a first data bus and a first data strobe signal bus, and the memory and the data buffer being coupled to each other via a second data bus and a second data strobe signal bus. The method comprises: transmitting the first data strobe signal between the memory controller and the data buffer via the first data strobe signal bus, wherein the first data strobe signal is a differential signal; transmitting the first data signal between the memory controller and the data buffer via the first data bus according to the first data strobe signal, wherein the first data signal is a differential signal; converting between the differential form and the single-ended form between the first data signal and the second data signal; transmitting the second data strobe signal between the data buffer and the memory via the second data strobe signal bus, wherein the second data strobe signal is a differential signal; and transmitting the second data signal between the data buffer and the memory via the second data bus based on the second data strobe signal, wherein the second data signal is a single-ended signal.

According to a further aspect of the present application, a data interaction method for a computer system is provided. The computer system includes a host, a memory, and a data buffer. The data buffer is coupled between the host and the memory. The host and the data buffer are coupled via a bidirectional differential data (DQ) bus and a bidirectional differential data strobe (DQS) bus. The memory and the data buffer are coupled via a bidirectional single-ended data (DQ) bus and another bidirectional differential DQS bus. The data interaction method in the embodiment includes: the host performs data interaction with the data buffer via the bidirectional differential DQ bus and the bidirectional differential DQS bus, where the DQS signal of the bidirectional differential DQS bus is used to sample the DQ signal of the bidirectional differential DQ bus; the data buffer buffers data exchanged between the host and the memory.

According to a further aspect of the present application, another data interaction method for a computer system is provided. The computer system includes a host and a memory. The host and the memory are coupled via a bidirectional differential data (DQ) bus and a bidirectional differential data strobe (DQS) bus. The data interaction method includes: the host performs data interaction with the memory via the bidirectional differential DQ bus and the bidirectional differential DQS bus, where the DQS signal of the bidirectional differential DQS bus is used to sample the DQ signal of the bidirectional differential DQ data bus.

The foregoing general description is an overview of the present application, which may involve simplification, generalization, and omission of details. Therefore, persons skilled in the art should recognize that this section is exemplary and explanatory only, and is not restrictive of the invention in any way. This general description is neither used to identify key or essential features of the claimed subject nor to serve as an aid in determining the scope of the claimed subject.

### BRIEF DESCRIPTION OF DRAWINGS

Through the combination of the following description, the appended claims and the drawings, the above and other features of the present application will be understood more fully and clearly. It can be understood that the drawings referenced herein illustrate only some several embodiments of the content of this application, and thus should not be regarded as limitation of the scope of the present application. The content of the present application will be illustrated more clearly and in detail through the drawings.

FIGS. 1(a) and 1(b) are diagrams illustrating access by a memory controller to an x4 DRAM and an x8 DRAM, respectively.

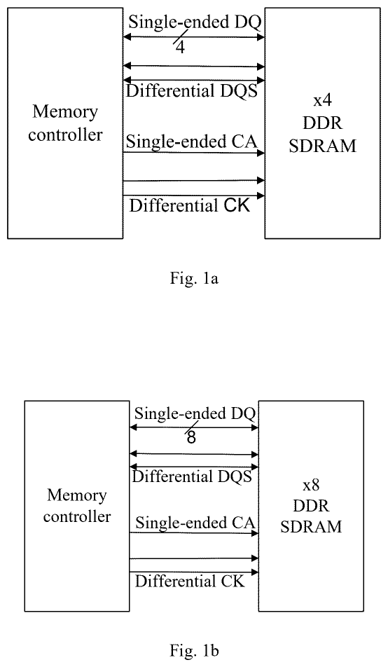

FIG. 2 illustrates a memory system 200 according to an embodiment of the present application.

FIG. 3 illustrates a memory system 300 according to another embodiment of the present application.

FIG. 4 illustrates a write method 400 for a memory system according to an embodiment of the present application.

FIG. 5 illustrates waveforms of signals on a portion of signal line/buses of the memory system 300 during a write operation.

FIG. 6 illustrates a read method 600 for a memory system according to an embodiment of the present application.

FIG. 7 illustrates waveforms of signals on a portion of signal line/buses of the memory system 300 during a read operation.

### DETAILED DESCRIPTION OF THE INVENTION

The following detailed description of exemplary embodiments of the application refers to the accompanying drawings that form a part of the description. In the drawings, similar symbols typically represent similar components unless otherwise specified by the context. The illustrative embodiments described in the detailed description, the drawings and the claims are not intended to limit. It can be understood that other embodiments may be employed and other changes may be made without departing from the spirit or scope of the present application. It can be understood that various configurations, substitutions, combinations, and designs of the various aspects of the present application that are generally described and illustrated in the drawings may be made, and all of these are incorporated as part of the present application.

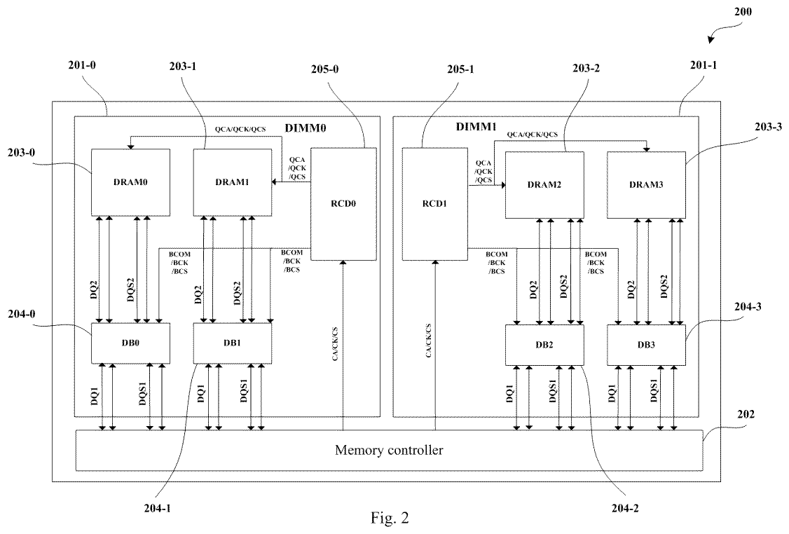

FIG. 2 illustrates a memory system 200 according to one embodiment of the present application. As shown in FIG. 2, the memory system 200 includes a plurality of DIMM memory modules, such as DIMM memory modules 201-0 and 201-1, which are capable of storing data therein during operation. The placement of the DIMM memory modules 201-0 and 201-1 in FIG. 2 is merely illustrative, and they may be placed arbitrarily as needed in this embodiment. It can be understood that in other embodiments, the number of DIMM memory modules may be greater than two, and the multiple DIMM memory modules may also be placed arbitrarily as required. The memory system 200 further includes a memory controller 202, which serves as an interface between the DIMM memory modules 201-0 and 201-1 and an external controller (e.g., a host), and controls access of the external controller to the memory system 200.

Each DIMM memory module may include at least one memory, data buffers coupled between the memory controller 202 and the memory, and a local controller, e.g., a Registering Clock Driver (RCD) which is also coupled between the at least one memory and the memory controller 202. The memory can be a dynamic random access memory (DRAM). The RCD is configured to buffer command/address (CA) signals, clock (CK) signals, and chip select (CS) signals from the memory controller 202. The data buffer is configured to buffer data interaction between the memory controller 202 and the memory. For example, the memory module 201-0 includes DRAMs 203-0 and 203-1, data buffers 204-0 and 204-1, and an RCD 205-0. The memory module 201-1 includes DRAMs 203-2 and 203-3, data buffers 204-2 and 204-3, and an RCD 205-1. It can be understood that, in other embodiments, the number of DRAMs included in a memory module may be any other positive integer other than two. In the embodiments of the present application, the local controller refers to a control logic or circuit within the memory module, such as those mounted on a printed circuit board of the memory module, which interact with the memory controller 202 via a memory interface.

Specifically, the memory controller 202 is coupled to the RCDs (the RCD 205-0 and the RCD 205-1 in the embodiment shown in FIG. 2) via respective CA buses, CK clock buses, and CS buses. The CA buses are used to provide command/address signals indicating specific access operations (e.g., write, read, chip select, chip deselect, etc.) to the memory banks, and the CK clock buses are used to provide CK clock signals for synchronizing the CA signals as well as other signals transmitted to the RCDs 205-0 and 205-1. The RCDs 205-0 and 205-1 each have a CA input coupled to a CA bus for receiving the CA signals. The RCDs 205-0 and 205-1 may forward the received CA signals, CK clock signals, and CS signals to the DRAMs 203-0 to 203-3 via their respective QCA signal buses, QCK signal buses, and QCS signal buses, to instruct the DRAMs 203-0 to 203-3 to proceed with operations. In some embodiments, the CK clock buses may be differential clock buses, one of which is used to transmit an in-phase clock signal and the other one of which is used to transmit an inverted clock signal. In some embodiments, the CA signals may be sampled at a crossing point of a rising edge of the in-phase clock signal and a falling edge of the inverted clock signal. The use of the clock signals in the differential form helps improve a signal-to-noise ratio and anti-interference capability of the circuit.

Still referring to FIG. 2, the memory controller 202 is coupled to the data buffers 204-0 to 204-3 via first data (DQ1) buses and first data strobe (DQS1) signal buses. The RCDs 205-0 and 205-1 may also be coupled to the data buffers 204-0 through 204-3 via clock signal (BCK) buses, command signal (BCOM) buses, and chip select signal (BCS) buses. The DQ1 buses may be bidirectional differential signal buses, and be used to transmit first data signals between the memory controller 202 and the data buffers 204-0 through 204-3. In this embodiment, the bidirectional DQ1 buses may be used for both data read and write operations, i.e., including a write direction from the memory controller 202 to the data buffers and a read direction from the data buffers to the memory controller 202. It can be understood that multiple pairs of bidirectional DQ1 buses may be included and respectively coupled to different data buffers, such that the plurality of data signal buses operate together to achieve efficient and stable memory access.

On the other hand, differential signal buses are paired signal buses, in which one signal bus is used to transmit an in-phase data signal and the other is used to transmit an inverted data signal. The in-phase and inverted data signals function together. In general, paired differential signal buses exhibit symmetry. When external crosstalk takes place, common-mode noise is introduced to the paired differential signal buses with the same amplitude and phase. Therefore, at the receiving end of the differential signal, subtracting the in-phase and inverted signals with each other can cancel the common-mode noise, and the resulting signal has an amplitude that is twice that of a single-ended signal, thereby improving a signal-to-noise ratio. Accordingly, adopting a differential signal format for the DQ1 buses also helps enhance the signal-to-noise ratio and anti-interference capability.

Similarly, the DQS1 buses are also paired bidirectional differential signal buses that transmit a first data strobe signal used for sampling the first data signal. In this embodiment, source synchronous transmission refers to that the first data strobe signal is transmitted together with the first data signal. Specifically, during data read operations, the first data strobe signal is generated by the data buffer and transmitted to the memory controller together with the first data signal; during data write operations, the first data strobe signal is generated by the memory controller and transmitted to the data buffer together with the first data signal. The first data strobe signal ensures that data is read or written at the correct timing. Data is synchronized in cycles by transmitting at the crossover points between the in-phase and inverted clock signals. During data read operations, the first data strobe signal and the first data signal are generated simultaneously, at the crossover point between the in-phase and inverted clock signals. When the first data strobe signal is generated, internal data prefetching within the data buffer has been completed; however, there is a delay between the triggering of the first data strobe signal and the actual existence of data on the first data buses. The differential signal design of the DQS1 buses also helps to improve the signal-to-noise ratio and interference immunity.

In this embodiment, the interconnection between the memory 203-0 and the data buffer 204-0 is used as an example to illustrate the connection relationship between the memory and the data buffer. The memory 203-0 and the data buffer 204-0 are coupled via second data (DQ2) buses and second data strobe (DQS2) buses. The DQ2 buses are single-ended signal buses used to transmit second data signals, and the DQS2 buses are bidirectional differential signal buses used to transmit second data strobe signals for sampling control of the second data signals. The connection relationships between other memories and data buffers are similar and are not described in detail.

JEDEC standards such as the DDR5 SDRAM standard (JESD79-5C.01_v1.31) published in July 2024, the DDR5 Registering Clock Driver-DDR5RCD01 standard (JESD82-511) published in August 2021, the DDR5 Registering Clock Driver-DDR5RCD02 standard (JESD82-512) published in February 2023, the DDR5 Registering Clock Driver-DDR5RCD03 standard (JESD82-513) also published in February 2023, the DDR5 Registering Clock Driver-DDR5RCD04 standard (JESD82-514.01) published in June 2024, and the DDR5 Data Buffer-DDR5DB01 Definition standard (JESD82-521) published in December 2021, as well as future publicly released JEDEC standards, provide further details on access operations for memory systems compliant with DDR standards. Herein, entire content of these standards is incorporated into the present application by reference. It can be understood that the memory system and data interaction method of the present application are compatible with the above-mentioned standards and other suitable DDR standards that may be released in the future.

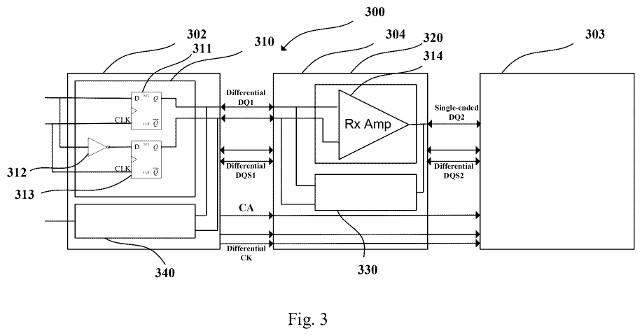

FIG. 3 illustrates a memory system 300 according to an embodiment of the present application.

As shown in FIG. 3, the memory system 300 includes a memory 303 and a data buffer 304, which are coupled to each other. Additionally, a memory controller 302 interacts with the data buffer 304 via bidirectional differential signal buses (DQ1 buses) and bidirectional data strobe signal buses (DQS1 buses) to achieve access to data stored in the memory 303. Specifically, in order to enable differential transmission and reception of the first data (DQ1) signals, the memory controller 302 and the data buffer 304 both include a modulation-demodulation circuit, which is used to modulate or demodulate the first data signal. In some embodiments, the modulation-demodulation circuit may be a Non-Return-to-Zero (NRZ) modulation and demodulation circuit or an N-level pulse amplitude modulation (PAM-N) and demodulation circuit, where N is an integer greater than 2. These modulation and demodulation circuits can employ corresponding modulation and demodulation algorithms, such as NRZ or pulse amplitude modulation and demodulation algorithms. It can be understood that other suitable algorithms may also be used, and the present application is not limited to any specific implementation. Accordingly, the first data signal from the memory controller 302 can be modulated by the modulation and demodulation circuit of the memory controller 302, and then be transmitted to the data buffer 304 over the DQ1 buses, and then demodulated by the modulation and demodulation circuit of the data buffer 304. It can be appreciated that a transmission process of the first data signal from the data buffer 304 to the memory controller 302 is implemented similarly.

Writing input data into the memory 303 is described as an example. In the embodiment shown in FIG. 3, the memory controller 302 includes an NRZ modulation circuit 310 for signal modulation. The NRZ modulation circuit 310 includes: a first D flip-flop 311, an inverter 312, and a second D flip-flop 313.

The first D flip-flop 311 is used to generate an in-phase signal. The first D flip-flop 311 includes a first data input terminal D, a first clock input terminal CLK, a first output terminal Q, and a complementary output terminal Q. The first output terminal Q is coupled to a transmission driver 315, which may be a buffer circuit to enhance load driving capability for the signals. The first data input terminal D is used to receive data signals to be modulated, which may be data signals sent to the memory controller from an external controller such as a processor or another external component. The first clock input CLK is used to receive trigger clock signals to control the operation timing of the first D flip-flop 311. In some specific implementations, the clock signal may be a gated clock signal. In particular, the clock signal is selectively activated or deactivated via a logical control signal, such that the clock signal can be activated only when desired to reduce system power consumption and electromagnetic interference. The first D flip-flop 311 can be edge-triggered, such as rising-edge or falling-edge triggered. It can be understood that the first D flip-flop 311 can also be other edge-triggered flip-flops, which are not limited in this embodiment. The first output terminal Q is used to selectively output a signal having the same logic level as the data signals to be modulated based on the state of the clock signal, thereby generating the in-phase signal. Specifically, when the valid clock edge arrives, the first output terminal Q outputs a signal having the same signal level as that of the input data signal as the in-phase signal.

The inverter 312 and the second D flip-flop 313 operate together to generate the inverted signal. Specifically, the inverter 312 is used to receive the data signal to be modulated and invert the data signal to be modulated to output an initial inverted data signal. The second data input terminal D of the second D flip-flop 313 is coupled to the inverter 312 to receive the initial inverted data signal. The second clock input terminal CLK of the second D flip-flop 313 is used to receive the same trigger clock signal as that of the first D flip-flop 311. The second output terminal Q of the second D flip-flop 313 is used to selectively output a signal with the same logic level as the initial inverted signal based on the state of the trigger clock signal to obtain the inverted signal. The second output terminal Q of the second D flip-flop 313 is coupled to a driver 316, which can also be a buffer circuit used to enhance the load driving capability. Since the second D flip-flop 313 receives an input signal that is inverted-phase relative to the data signal to be modulated, an output of the second output terminal Q will accordingly be inverted with respect to the data signal to be modulated. With the aforementioned structure and operation, the in-phase signal from the first D flip-flop 311 and the inverted signal from the second D flip-flop 313 form a differential signal pair, which serves as the first data signal. As a result, the memory controller 302 can transmit the first data signal to the data buffer 304 over the bidirectional differential DQ1 buses. Moreover, using the first D flip-flop, the second D flip-flop, and the inverter to generate differential signals has the following advantages. First, the use of an inverter introduces delay in the initial inverted signal relative to the data signal to be modulated. However, since both the first D flip-flop and the second D flip-flop use the same trigger clock signal, they can be triggered by the same clock signal edge, which ensures that the in-phase signal and the inverted signal are updated synchronously, thereby eliminating any phase offset between them. Additionally, the D flip-flops can sample inputs only at the clock edge, which help effectively filter out glitches in the input signal.

Accordingly, the data buffer 304 demodulates the first data signal after receiving the first data signal. In the embodiment shown in FIG. 3, the data buffer 304 includes a non-return-to-zero (NRZ) demodulation circuit 320 for demodulating signals. Specifically, the NRZ demodulation circuit 320 includes a differential amplifier 314. The differential amplifier 314 includes: an in-phase input terminal coupled to a signal bus of the first data buses that transmits the in-phase signal, which is used for receiving the in-phase signal; an inverted input terminal coupled to another signal bus of the first data buses that transmits the inverted signal, which is used for receiving the inverted signal; and an output terminal for outputting a gain signal of a differential signal between the in-phase signal and the inverted signal. The output terminal of the differential amplifier 314 may also be coupled to a transmit driver 317, which may be a buffer circuit configured to enhance the load driving capability of signals. Assuming the in-phase signal is indicated by V+, the inverted signal is indicated by V−, and the gain of the differential amplifier 314 is indicated by A, the output signal at the output terminal is V0=(V+−V−)×A. After demodulation, the differential signal is converted into a single-ended signal, which is a second data signal (a DQ2 signal). Subsequently, the data buffer 304 may transmit the second data signal to the memory 303 via the second data (DQ2) buses.

The above describes the write operation to the memory 303. When the memory controller 302 reads data from the memory 303 via the data buffer 304, the memory controller 302 and the data buffer 304 perform corresponding operations using a similar modulation and demodulation circuit structure. An input terminal of a NRZ modulation circuit 330 may be coupled to a receive driver 331, and an output terminal of the NRZ modulation circuit 330 may be coupled to transmit drivers 332 and 333. An input terminal of a NRZ demodulation circuit 340 may be coupled to receive drivers 341 and 342. The receive drivers 331, 341 and 342 can correct signal distortion caused by noises and match impedance of transmission lines to maintain signal stability and integrity. The transmit drivers 332 and 333 can enhance driving capability of signals. The memory 303 transmits the second data signal to the data buffer 304 via the DQ2 buses. The data buffer 304 includes the NRZ modulation circuit 330, whose structure can be referred to that of the NRZ modulation circuit 310 and will not be repeated here. At this time, the data signal to be modulated is the second data signal. After modulation by the NRZ modulation circuit 330, the second data signal is converted into in-phase and inverted signals as the first data signal, and transmitted to the memory controller 302 via the DQ1 buses. The memory controller 302 includes the NRZ demodulation circuit 340. The structure of the NRZ demodulation circuit 340 can be referred to that of the NRZ demodulation circuit 320 and will not be repeated here. Similarly, the NRZ demodulation circuit 340 receives the first data signal for demodulation, thereby obtaining the gain signal of the difference between the in-phase and inverted signals.

It can be understood that when an NRZ modulation and demodulation circuit is used, since a differential signal bus is adopted, only 1-bit information can be transmitted at each unit interval. Therefore, the number of data buses required is twice that of data buses when a single-ended signal is used. Accordingly, in some other embodiments, the modulation/demodulation circuit may be an N-level pulse amplitude modulation and demodulation circuit, such as a 4-level PAM and demodulation circuit.

By adopting a 4-level PAM and demodulation circuit, 2 bits of data can be transmitted at each unit interval, and the number of data buses is the same as that of data buses when a single-ended signal is used. Therefore, the number of interfaces and the number of data buses between the data buffer and the memory do not change compared with the case that a single-ended signal is used, and thus there is no need to redesign the memory. Moreover, the amplitude of the signal demodulated from a 4-level PAM signal is twice that of the NRZ signal, and this type of modulation and demodulation circuit provides better crosstalk suppression capability.

In the memory system shown in FIG. 3, the memory controller, the memory and the data buffer are provided as separate components. However, in other embodiments, such as those shown in the following embodiments, the data buffer may be packaged together with a memory die that is provided separately, or the memory controller may be integrated into a host or similar device that is provided separately.

One embodiment of the present application provides another memory system, which may be a memory module that ca be provided separately. The memory system includes a memory and a data buffer. The data buffer includes a first data signal port and a first data strobe signal port. The data buffer is used to be coupled to a first data bus via the first data signal port, and further coupled to a memory controller via the first data bus. The data buffer is also coupled to a first data strobe signal bus via the first data strobe signal port, and further coupled to the memory controller via the first data strobe signal bus. The first data bus is used to transmit a first data signal, and the first data strobe signal bus is used to transmit a first data strobe signal for sampling control of the first data signal. Both the first data signal port and the first data strobe signal port are bidirectional differential signal ports. The memory and the data buffer are coupled to each other via a second data bus and a second data strobe signal bus. The second data bus is used to transmit a second data signal, and the second data strobe signal bus is used to transmit a second data strobe signal for sampling control of the second data signal. The second data bus is a single-ended signal bus, and the second data strobe signal bus is a bidirectional differential signal bus. The functions and connection relationships of the components in this embodiment can be referred to those in the embodiment shown in FIG. 3. The details are not repeated here.

Another embodiment of the present application provides a further memory system, which may be a host or other similar device that is separately provided. The memory system includes a memory controller and a data buffer. The memory controller and the data buffer are coupled to each other via a first data bus and a first data strobe signal bus. The first data bus is used to transmit a first data signal, and the first data strobe signal bus is used to transmit a first data strobe signal for sampling control of the first data signal. Both the first data bus and the first data strobe signal bus are bidirectional differential signal buses. The data buffer includes a second data signal port and a second data strobe signal port. The data buffer is coupled to a second data bus via the second data signal port, and further coupled to a memory via the second data bus. The data buffer is also coupled to a second data strobe signal bus via the second data strobe signal port, and further coupled to the memory via the second data strobe signal bus. The second data bus is used to transmit a second data signal, and the second data strobe signal bus is used to transmit a second data strobe signal for sampling control of the second data signal. The second data signal port is a single-ended signal port, and the second data strobe signal port is a bidirectional differential signal port. The functions and connection relationships of the components in this embodiment can be referred to those in the embodiment shown in FIG. 3. The details are not repeated here.

One embodiment of the present application provides a computer system. The computer system includes a host, a memory and a data buffer. The data buffer is located between the host and the memory and is used to buffer data interactions between the host and the memory. The host and the data buffer are coupled to each other via a bidirectional differential DQ bus and a bidirectional differential DQS bus. DQS signals on the bidirectional differential DQS bus are used to sample DQ signals on the bidirectional differential DQ bus. The memory and the data buffer are coupled to each other via a bidirectional single-ended DQ bus and a bidirectional differential DQS bus. The host in this embodiment can be referred to the description of the memory controller in the embodiment shown in FIG. 3, and the data buffer and memory can be referred to the corresponding descriptions in the embodiment shown in FIG. 3. The details are not repeated here.

An embodiment of the present application provides another computer system. The computer system includes a host and a memory. The host and the memory are coupled via a bidirectional differential DQ bus and a bidirectional differential DQS bus, and DQS signals on the bidirectional differential DQS bus are used to sample DQ signals on the bidirectional differential DQ data bus. In this embodiment, the host and the memory are directly connected together instead of through a data buffer. The host in this embodiment can be referred to the memory controller described in the embodiment shown in FIG. 3. The memory can also be referred to the memory described in FIG. 3, which includes a modulation and demodulation circuit. The details are not repeated here.

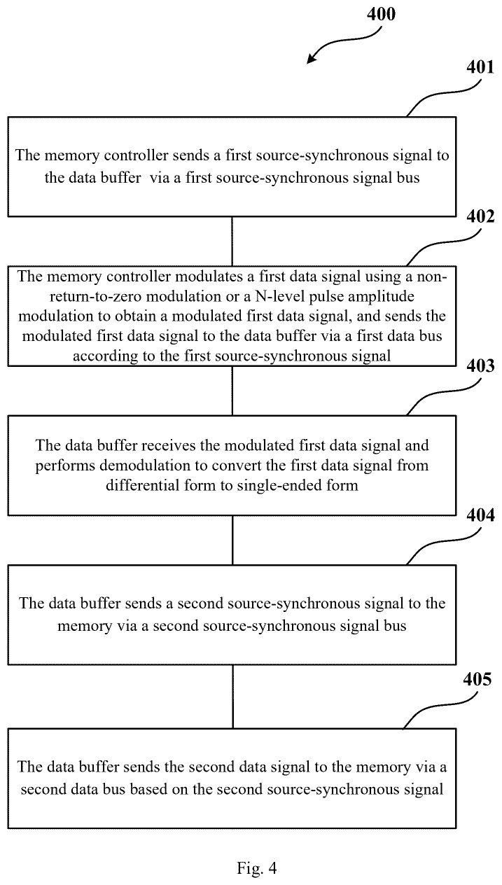

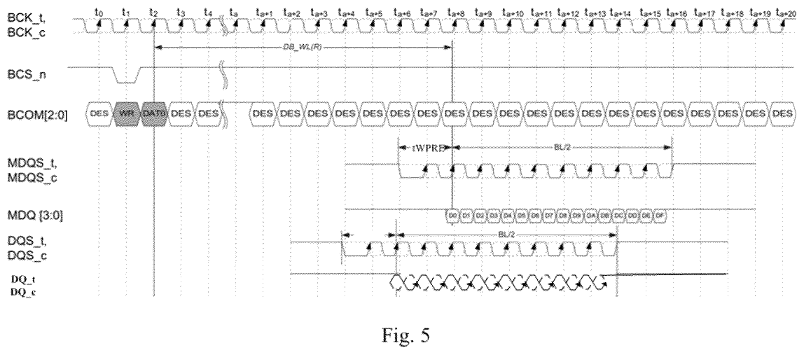

FIG. 4 illustrates a write method 400 for a memory system according to an embodiment of the present application. For example, the write method 400 may be executed by the memory system shown in FIG. 3. The method 400 adopts a differential signal for data transmission between a memory controller and a data buffer, which improves signal integrity and anti-interference capability. FIG. 5 shows waveforms of signals on a portion of the signal line/buses of the memory system 300 during a write operation performed using this method.

The method 400 is described in detail below with reference to FIGS. 3 to 5.

Specifically, in step 401, the memory controller 302 sends a first data strobe signal to the data buffer 304 via a first data strobe signal (DQS1) bus. The first data strobe signal is a differential signal. In step 402, the memory controller 302 modulates a first data signal using non-return-to-zero (NRZ) modulation or N-level pulse amplitude modulation (PAM-N) to obtain a modulated first data signal, and sends the modulated first data signal to the data buffer 304 via a first data (DQ1) bus according to the first data strobe signal, where the first data signal is a differential signal. In step 403, the data buffer 304 receives the modulated first data signal and performs demodulation to convert the form of the first data signal from the differential form into the single-ended form, thereby obtaining a second data signal. In step 404, the data buffer 304 sends a second data strobe signal to the memory 303 via a second data strobe signal (DQS2) bus, where the second data strobe signal is a differential signal. In step 405, the data buffer 304 sends the second data signal to the memory 303 via a second data (DQ2) bus based on the second data strobe signal. It should be noted that the division of steps 401 to 405 does not denote a sequential order of execution. In practical implementations, steps 401 and 402 may be executed simultaneously, and steps 404 and 405 may also be executed simultaneously.

In FIG. 5, signals BCK_t and BCK_c represent differential clock signals. A signal BCS_n is a chip select signal, which is active low and used to enable the corresponding memory chip. The memory chip responds to other control and data signals based on the valid chip select signal only when the BCS_n is low. A signal BCOM[2:0] represents the command signal. As illustrated in FIG. 5, through the command signal BCOM[2:0], a “WR” write command which indicates a write operation can be transmitted by the bus. It can be understood that the signal BCOM[2:0] can also be used to transmit a read command “RD” or other commands, which will be described in detail later. A signals DQ [3:0] represents the first data signal, a signal DQS [3:0] represents the first data strobe signal, a signal MDQ[3:0] represents the second data signal, and a signal MDQS[3:0] represents the second data strobe signal.

The timing of the write operation is as follows. The memory controller 302 outputs a low-level BCS_n signal, i.e., the chip select signal is active. Further, the memory controller 302 issues a “WR” write command via BCOM[2:0] and sends it to the data buffer 304. Subsequently, the data buffer 304 generates the pre-amble tWPRE. Then, data-burst transmission takes place between the memory controller 302 and the data buffer 304. Specifically, synchronized with the clock signals BCK_t and BCK_c, the memory controller 302 sends data to the data buffer 304 via DQ/DQS (e.g., DQ1/DQS1 in FIG. 3). The data buffer 304 then sends the data to the memory 303 via MDQ/MDQS (e.g., DQ2/DQS2 in FIG. 3), and the write operation is completed. It can be understood that the amount and timing of data transmission are controlled by parameters such as burst length (BL). Burst transmission refers to a method in DDR for continuously transferring multiple data units in a single operation, where BL specifies the amount of data transmitted per burst. Additional data transfer rules and methods may be referred to the JEDEC standards for DDR SDRAM.

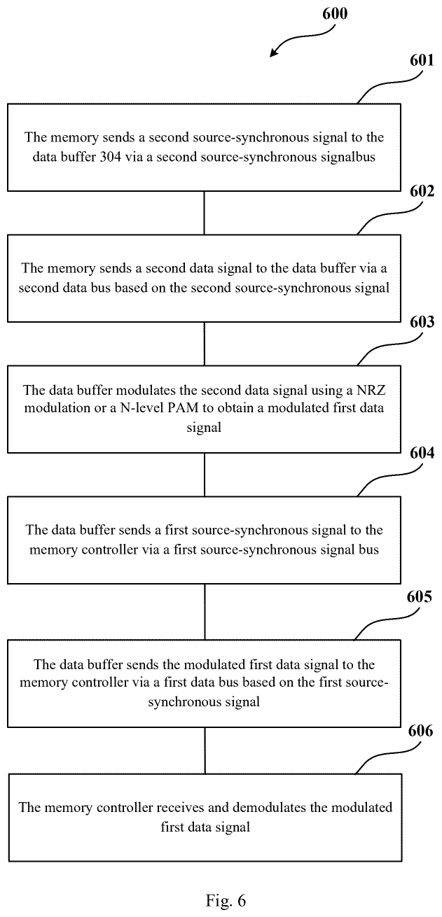

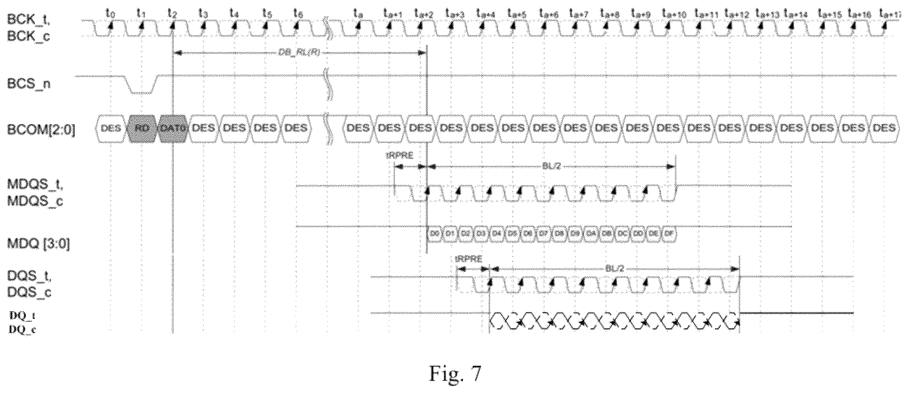

FIG. 6 illustrates a read method 600 for a memory system according to another embodiment of the present application. For example, the read method 600 may be executed by the memory system shown in FIG. 3. The method 600 adopts a differential signal for data transmission between a memory controller and a data buffer, which improves signal integrity and anti-interference capability. FIG. 7 shows waveforms of signals on a portion of the signal line/buses of the memory system 300 during a read operation performed using this method.

The method 600 is described in detail below with reference to FIGS. 3, 6 and 7.

Specifically, in step 601, the memory 303 sends a second data strobe signal to the data buffer 304 via a second data strobe signal (DQS2) bus. The second data strobe signal is a differential signal. In step 602, the memory 303 sends a second data signal to the data buffer 304 via a second data (DQ2) bus based on the second data strobe signal, where the second data signal is a single-ended signal. In step 603, the data buffer 304 modulates the second data signal using NRZ modulation or N-level PAM to obtain a modulated first data signal, which is a differential signal. In step 604, the data buffer 304 sends a first data strobe signal to the memory controller 302 via a first data strobe signal (DQS1) bus, where the first data strobe signal is a differential signal. In step 605, the data buffer 304 sends the modulated first data signal to the memory controller 302 via a first data (DQ1) bus based on the first data strobe signal. In step 606, the memory controller 302 receives and demodulates the modulated first data signal. It should be noted that the division of steps 601 to 606 does not denote a sequential order of execution. In practical implementations, steps 601 and 602 may be executed simultaneously, and steps 604 and 605 may also be executed simultaneously.

The timing of the read operation is as follows. The memory controller 302 outputs a low-level BCS_n signal, i.e., the chip select signal is active. Further, the memory controller 302 issues a “RD” read command via BCOM[2:0] and sends it to the data buffer 304. Subsequently, the data buffer 304 generates the pre-amble tRPRE. Then, data-burst transmission takes place between the memory controller 302 and the data buffer 304. Specifically, synchronized with the clock signals BCK_t and BCK_c, the memory 303 sends data to the data buffer 304 via MDQ/MDQS. The data buffer 304 then sends the data to the memory controller 302 via DQ/DQS, and the read operation is completed.

In the embodiment, the differential signal format is used for both data and data strobe signals in read and write operations between the memory controller and the data buffer, which helps to improve signal integrity and anti-interference capability. In addition, modulation and demodulation circuits are employed to enable the transmission and reception of differential signals.

An embodiment of the present application provides a data interaction method for a computer system. The computer system includes a host, a memory, and a data buffer. The data buffer is coupled between the host and the memory. The host and the data buffer are coupled via a bidirectional differential data (DQ) bus and a bidirectional differential data strobe (DQS) bus. The memory and the data buffer are coupled via a bidirectional single-ended data (DQ) bus and another bidirectional differential DQS bus. The data interaction method in the embodiment includes: the host performs data interaction with the data buffer via the bidirectional differential DQ bus and the bidirectional differential DQS bus, where the DQS signal of the bidirectional differential DQS bus is used to sample the DQ signal of the bidirectional differential DQ bus; the data buffer buffers data exchanged between the host and the memory.

Another embodiment of the present application provides another data interaction method for a computer system. The computer system includes a host and a memory. The host and the memory are coupled via a bidirectional differential data (DQ) bus and a bidirectional differential data strobe (DQS) bus. The data interaction method includes: the host performs data interaction with the memory via the bidirectional differential DQ bus and the bidirectional differential DQS bus, where the DQS signal of the bidirectional differential DQS bus is used to sample the DQ signal of the bidirectional differential DQ data bus.

It should be noted that although certain steps of data interaction methods for memory systems and computer systems, as well as various components or modules of such systems are detailed in the foregoing description, such divisions are merely exemplary and not mandatory. In practice, according to the embodiments of the present application, the features and functions of two or more modules described above can be implemented in a single module. Conversely, the features and functions of a single module described above can be further divided and implemented by multiple modules.

Persons skilled in the art can understand and implement other modifications to the disclosed embodiments by studying the description, disclosed content, drawings, and appended claims. In the claims, the wording “comprises” does not exclude other elements or steps, and the wording “a” or “an” does not exclude the plural. In practical applications of this disclosure, a single component may perform the functions of multiple technical features cited in the claims. Reference numerals in the claims should not be construed as limiting the scope.

1. A memory system, comprising:
a memory controller;
a memory; and
a data buffer, coupled between the memory controller and the memory, and configured to buffer data interacted between the memory controller and the memory;
wherein the memory controller and the data buffer are coupled to each other via a first data bus and a first data strobe signal bus, the first data bus being configured to transmit a first data signal, and the first data strobe signal bus being configured to transmit a first data strobe signal for sampling control of the first data signal, wherein the first data bus and the first data strobe signal bus are both bidirectional differential signal buses; and
wherein the memory and the data buffer are coupled to each other via a second data bus and a second data strobe signal bus, the second data bus being configured to transmit a second data signal, and the second data strobe signal bus being configured to transmit a second data strobe signal for sampling control of the second data signal, wherein the second data bus is a single-ended signal bus, and the second data strobe signal bus is a bidirectional differential signal bus.

2. The memory system of claim 1, wherein the memory controller and the data buffer respectively comprise a modulation and demodulation circuit, which is configured to modulate or demodulate the first data signal; wherein the modulation and demodulation circuit is a non-return-to-zero modulation and demodulation circuit or an N-level pulse amplitude modulation and demodulation circuit, where N is an integer greater than 2.

3. The memory system of claim 2, wherein the modulation and demodulation circuit is a non-return-to-zero modulation and demodulation circuit, and the first data signal comprises an in-phase signal and an inverted signal, and the non-return-to-zero modulation and demodulation circuit comprises:
a first D flip-flop configured to generate the in-phase signal, comprising:
a first data input terminal configured to receive a data signal to be modulated, wherein when the non-return-to-zero modulation and demodulation circuit is located in the memory controller, the data signal to be modulated is a data signal transmitted from an external controller to the memory controller, and when the non-return-to-zero modulation and demodulation circuit is located in the data buffer, the data signal to be modulated is the second data signal;
a first clock input terminal configured to receive a flip-flop clock signal;
a first output terminal configured to selectively output a signal having the same logic level as the data signal to be modulated based on the state of the flip-flop clock signal to obtain the in-phase signal;
an inverter configured to receive the data signal to be modulated and invert the data signal to be modulated to output an initial inverted data signal; and
a second D flip-flop configured to generate the inverted signal, comprising:
a second data input terminal coupled to the inverter to receive the initial inverted data signal output from the inverter;
a second clock input terminal configured to receive the flip-flop clock signal;
a second output terminal configured to selectively output a signal having the same logic level as the initial inverted data signal based on the state of the flip-flop clock signal to obtain the inverted signal.

4. The memory system of claim 3, wherein the non-return-to-zero modulation and demodulation circuit further comprises a differential amplifier;
the differential amplifier comprises:
an in-phase input terminal, coupled to a signal bus of the first data bus configured to transmit the in-phase signal, and configured to receive the in-phase signal;
an inverted input terminal, coupled to a signal line of the first data bus configured to transmit the inverted signal, and configured to receive the inverted signal; and
an output terminal configured to output a gain signal of the differential signal between the in-phase signal and the inverted signal.

5. A memory system, comprising:
a memory; and
a data buffer;
wherein the data buffer comprises a first data signal port and a first data strobe signal port, the data buffer being configured to be coupled to a first data bus via the first data signal port, thereby coupled to a memory controller via the first data bus, and further configured to be coupled to a first data strobe signal bus via the first data strobe signal port, thereby coupled to the memory controller via the first data strobe signal bus; wherein the first data bus is configured to transmit a first data signal, and the first data strobe signal bus is configured to transmit a first data strobe signal for sampling control of the first data signal, wherein the first data signal port and the first data strobe signal port are both bidirectional differential signal ports; and
wherein the memory and the data buffer are coupled to each other via a second data bus and a second data strobe signal bus, the second data bus being configured to transmit a second data signal, and the second data strobe signal bus being configured to transmit a second data strobe signal for sampling control of the second data signal, wherein the second data bus is a single-ended signal bus, and the second data strobe signal bus is a bidirectional differential signal bus.

6. A data interaction method for a memory system, wherein the memory system comprises a memory controller, a memory, and a data buffer, the data buffer being coupled between the memory controller and the memory, the memory controller and the data buffer being coupled to each other via a first data bus and a first data strobe signal bus, and the memory and the data buffer being coupled to each other via a second data bus and a second data strobe signal bus, the method comprising:
transmitting a first data strobe signal between the memory controller and the data buffer via the first data strobe signal bus, wherein the first data strobe signal is a differential signal;
transmitting a first data signal between the memory controller and the data buffer via the first data bus according to the first data strobe signal, wherein the first data signal is a differential signal;
converting between the differential form and the single-ended form between the first data signal and the second data signal;
transmitting the second data strobe signal between the data buffer and the memory via the second data strobe signal bus, wherein the second data strobe signal is a differential signal; and
transmitting the second data signal between the data buffer and the memory via the second data bus based on the second data strobe signal, wherein the second data signal is a single-ended signal.

7. The method of claim 6, wherein the memory controller and the data buffer respectively comprise a modulation and demodulation circuit, the modulation and demodulation circuit being a non-return-to-zero modulation and demodulation circuit or an N-level pulse amplitude modulation and demodulation circuit, where N is an integer greater than 2; the method further comprises:
modulating or demodulating the first data signal via the modulation and demodulation circuit.
